(19) United States
(12) Patent Application Publication
(10) Pub. No.: US 2022/0022712 A1
(43) Pub. Date: Jan. 27, 2022

(54) DEVICE FOR CLEANING DIRTY SURFACES

(71) Applicant: KEMARO AG, Eschlikon (CH)

(72) Inventors: Martin GADIENT, Bichelsee (CH); Thomas OBERHOLZER, Schwarzenbach (CH); Armin KOLLER, Bronschhofen (CH)

(21) Appl. No.: 17/311,736

(22) PCT Filed: Dec. 10, 2019
(86) PCT No.: PCT/EP2019/084399

§ 371 Date: Jun. 8, 2021

(51) Int. Cl. A47L 9/28; A47L 11/40; A47L 11/24; A47L 11/30; A47L 9/00; A47L 9/16; G01B 5/18

(52) U.S. Cl. CPC A47L 9/2805; A47L 11/4061; A47L 11/24; A47L 11/305; A47L 11/4011; A47L 2201/04; A47L 9/009; A47L 9/1683; A47L 9/2815; G01B 5/18; A47L 11/4072

(57) ABSTRACT

A device (1) for automatically performing an activity, in particular for cleaning dirty surfaces, having at least one sensor (3) and at least one drive element (4). The drive element (4) divides the device (1) into a rear region (11) and a front region (12), on the basis of the intended direction of movement (B). The sensor (3) is a mechanical sensor which is arranged in the front region (12) of the device (1) and is used to determine, by contact with the floor, a change in the height of the floor.

The invention relates to a device and to a method for automatically performing an activity, in particular for cleaning dirty surfaces, according to the preamble of the independent claims.

Various devices which have the purpose of automatically performing an activity and which are used, in particular, for cleaning dirty surfaces are known from the prior art. The purpose of the devices is to facilitate the activity which is to be performed for the human being. For this purpose, the devices must be able to maneuver automatically, detect obstacles and automatically perform the activity which is to be performed. A particular challenge is to avoid falling over edges.

DE 102012108008 discloses a suction device which uses an infrared sensor to prevent the device from falling.

A disadvantage with the prior art is that the device cannot be used in an environment with dust emissions, since the infrared sensor is susceptible to faults with respect to dust emissions.

U.S. Pat. No. 6,580,246 discloses an automatic sweeping device which detects obstacles when the device body moves. The device body movement is measured by means of magnetic sensors.

The disadvantage here is that the device cannot be reliably prevented from falling.

The object of the present invention is to provide a device which has the purpose of automatically performing an activity and which avoids the disadvantages of the prior art, and in particular to provide a device and a method for automatically performing an activity so that the device is prevented from falling in an environment with dirt emissions.

This object is achieved by means of a device and a method for automatically performing an activity, in particular for cleaning dirty surfaces, according to the independent claims.

According to the invention, the device for automatically performing an activity, in particular for cleaning dirty surfaces, according to a first aspect of the invention comprises at least one sensor and at least one drive element, wherein the drive element can be a wheel but also a caterpillar track. The drive element divides the device into a rear area and a front area with respect to an intended direction of movement. According to the invention, the sensor is a mechanical sensor which serves, through contact with the floor, to detect a change in the level of the floor and is arranged in the front area of the device. Therefore, in particular edges can be detected so that the sensor serves as a fall prevention means.

In this context, the term mechanical means that the change in the level is sensed by a movable sensor element. Electrical or optical methods, for example, are applied for the detection of a movement of the sensor element. A two-part magnetic safety switch is preferably used.

However, it is also alternatively possible to use inductive sensors, capacitive sensors, acceleration sensors, ultrasonic sensors or RFID sensors, Reed sensors, Hall sensors, piezo sensors and resistance sensors, strain gauges, pushbutton switches, angle sensors, in order to sense a movement of the mechanical sensor element.

In this context, the arrangement of the sensor for preventing falls is to be understood in such a way that for a specific direction movement of the device in the 360° radius, a sensor is arranged in the front area of the device with respect to this direction of movement. When there are a plurality of possible movements, a plurality of sensors are also conceivable. If the device also moves, for example, in a rearward direction, a sensor for preventing falls with respect to the rearward movement can be additionally arranged in the front area of the device.

By means of a device with a mechanical sensor for detecting a change in the level of the floor, the device can also be used in surroundings with dust emissions. The arrangement of the sensor in the front area of the device has the advantage that the triggering of the sensor results in immediate stopping of the device and prevents falls in good time.

The mechanical sensor is preferably embodied as a pressure sensor, strain sensor or force sensor.

Through the use of a mechanical sensor whose measurement is carried out by means of pressure, strain or force, incorrect measurements can be reduced in respect of sensors which are susceptible when there are dirt emissions.

The sensor is preferably integrated into a carrier of a wheel, in particular a caster. However, said sensor can basically be integrated into any type of wheel in the front area, e.g. into an omnidirectional wheel or mecanum wheel.

This permits a simple design of the sensor. Since the wheel is already in contact with the floor, an additional mechanism for bringing about contact of the sensor with the floor when necessary can be dispensed with.

The sensor is preferably arranged in particular in the center of rotating brushes.

The sensor is preferably arranged in such a way that the dirt is already removed when the sensor enters into contact with the floor.

As a result of the position of the sensor, it is protected against dirt on the floor and incorrect measurements which are caused thereby. Furthermore unsecured objects on the floor are prevented from triggering the sensor.

Alternatively, at least one contact plate, preferably two contact plates, can be used. The contact plate or plates is/are arranged in the front area, behind one or more steering wheels. The contact plate or plates is/are not in contact with the floor as long as the steering wheels are in contact with the floor. When there is an abrupt change in the level of the floor, the casters lose contact with the floor and a contact is brought about between one contact plate or both contact plates and the floor. As a result a signal can be generated and therefore a fall can be prevented.

According to a further aspect, a device for automatically cleaning dirty surfaces comprises at least one cleaning apparatus. The cleaning apparatus comprises an emptying apparatus which comprises a dirt receptacle space for receiving the collected dirt. The emptying apparatus can move automatically between an operating position, in which it receives dirt from the cleaning apparatus, and an emptying position, in which it empties dirt out of the dirt receptacle space. The emptying apparatus can be moved automatically by means of an internal or an external drive.

For the purpose of activation with an external drive, the device can be provided with a clutch to which the external drive can be coupled.

Alternatively it is also conceivable to form an operative connection between the emptying apparatus and an external restraining arrangement. Through selective movement of the device when the emptying apparatus is restrained, the emptying apparatus can move from the operating position into the emptying position.

As a result, the device can empty the collected dirt automatically and without manual assistance, and makes available new filling space for the further collection of dirt. Long downtimes are avoided in order to ensure efficient and rapid cleaning. Furthermore, the automatic emptying of the device makes a higher degree of autonomy possible, and no personnel are required. It is conceivable that the dirt container can also be emptied manually when necessary.

The device preferably comprises a dirt receptacle space and a closure element which is movably arranged on the device. The closure element can be capable of being tilted, folded open and/or pulled out.

The movably arranged closure element permits the dirt receptacle space to be opened automatically and without manual assistance.

The emptying apparatus preferably comprises a filling level sensor for determining a residual volume.

This permits simple determination of the dirt receptacle volume which is still present in the dirt receptacle space.

According to a further aspect, a device for automatically cleaning dirty surfaces comprises at least one cleaning apparatus and one blowing apparatus for generating an air flow. The blowing apparatus can be formed by a suction apparatus for suctioning air. In this case, the suction apparatus preferably has a filter arrangement for filtering particles from the suctioned air. The device also comprises an optical detection system, preferably with an image recognition system and/or a LIDAR sensor, e.g. for detecting obstacles. An air guide of the blowing apparatus, and in particular an exhaust air guide of the filter arrangement, are arranged in such a way that air and preferably filtered exhaust air is guided past a detection unit of the optical detection system. The detection unit is typically a camera but can also be a laser distance measuring unit or an IR sensor.

As a result, dirt is carried away from an area in front of the optical detection unit, and the dirt-sensitive detection unit is protected against dirt emissions, and susceptibility to faults which result therefrom is reduced.

The above cleaning apparatus in all its aspects preferably comprises a sweeping apparatus.

As a result, a sweeping apparatus for cleaning dirty surfaces can be maneuvered in an environment with dirt emissions using an image recognition system.

According to a further aspect, the device for automatically performing an activity comprises at least one cleaning apparatus and one transport aid which can be activated. The transport aid can have a pull-out handle which is attached to one end of the device. At least one wheel is arranged at the opposite end. This wheel can be a transportation wheel which enters into contact with the floor only in the case of transportation, or else a drive wheel which can be decoupled or has no a self-locking mechanism. If the device is moved into a transportation position, the wheel is already in contact with the floor or enters into contact with the floor. The described principle is similar to that of a commercially available suitcase trolley with two wheels. In the transportation position the two wheels are in contact with the floor and permit simplified and easy manual movement of the device in the manner of a suitcase trolley.

As a result, the device can be easily moved along manually.

Alternatively, the transport aid is formed by a pull-out line which is arranged on the housing. The device then has at least three wheels which are in contact with the floor, which can be uncoupled or which do not have a self-locking mechanism. The wheels are preferably arranged in such a way that at least one wheel is arranged at one end of the device and at least two wheels are arranged at the opposite end and are in contact with the floor.

The object is also achieved by a method for automatically cleaning dirty surfaces by means of a device.

The method comprises the steps:
measuring a specified setpoint value of a residual volume of a dirt receptacle space,
if the setpoint value is reached, moving the device into a position which is adjacent to a dirt collection area,
automatically opening the movable dirt receptacle space, and
emptying the dirt out of the dirt receptacle space into the dirt collection area.

The setpoint value can be here, for example, a predetermined filling level, a filling weight and/or a point in time.

The advantage of this method is autonomous operation and automatic, efficient and rapid detection by the device as to when the device is to move to the dirt receptacle area.

The object is also achieved by a method for automatically cleaning dirty surfaces by means of a device.

The method comprises the steps:
detecting a change in the level in an area of the floor lying in front of the drive element in the direction of movement through contact of a sensor with the floor,
if no change in the level of the floor is detected, continuing a cleaning process, and
if a change in the level of the floor is detected, ending the locomotion of the device and optionally outputting a signal and/or implementing a change in direction.

The advantage of this method is automatic, efficient or rapid detection of a change in the level of the floor, in order to prevent the device from falling and/or being damaged. A signal which is to be output can be an optical signal, an audible signal or a wireless fault message, via radio, mail or SMS.

The object is also achieved by a method for automatically cleaning dirty surfaces by means of a device.

The method comprises the steps:
determining the location of an image which is assigned spatially to a station, by means of a LIDAR sensor or an image recognition system,
determining the relative position of the device with respect to the station by means of LIDAR sensor or a 3D camera in real time, by measuring at least one distance from the image whose location has been determined, and
moving the device to the station on the basis of the determined relative position.

The method also preferably comprises the steps:
determining a code provided by the image, and
performing an action which is assigned to the code.

Alternatively, the LIDAR sensor or the camera can be designed to sense and evaluate a 3D code.

Advantages of this method are the precise determination of the actual position of the device and the execution of an action when a code is detected.

The method for automatically cleaning dirty surfaces by means of a device preferably comprises the following steps:
if a setpoint value does not correspond to a setpoint criterion, continuing a cleaning process,
moving the device if the setpoint value corresponds to the setpoint criterion, in particular to a charging station or to a dirt receptacle station in the dirt collection area, and
if the station is reached, executing a command, in particular docking and charging until the maximum charging capacity is reached or emptying the dirt receptacle space.

A setpoint criterion can be a load state, a filling level or a filling weight of the dirt collection container.

The advantage of this method is the automatic movement to a station when a predetermined setpoint criterion is satisfied. A station may be, for example, a charging station or the dirt receptacle area.

This object is also achieved by a method for automatically cleaning dirty surfaces by means of a device.

The method comprises the steps:
generating an air flow, in particular by suctioning air by means of a suction apparatus,
optionally filtering an exhaust air flow of the suction apparatus by means of a filter arrangement, and
removing dirt from an area adjacent to an optical detection system, in particular a camera, by guiding the air flow, in particular the filtered exhaust air flow, past.

An air blower or else a compressed air source can also be used as an alternative to a suction apparatus.

With such a method it is possible to use optical sensors which are sensitive to dirt emissions, in an environment with dirt emissions. Dirt is transported away from the area adjacent to the optical detection system before said dirt can become deposited, e.g. on a lens, or dirt which has already been deposited can, if necessary, also be removed.

The object is also achieved by a method for automatically cleaning dirty surfaces by means of a device.

The method comprises the steps:
detecting one or more references by means of a sensor, in particular a light sensor, and
determining an action area on the basis of the determined one or more references. The movement of the device is controlled in such a way that the action area is not exited. However, it is also conceivable that predetermined actions are triggered when the reference is detected.

References can function on the basis of random passive elements (i.e. elements which do not require a power supply), in particular can be embodied by means of the detection of electromagnetic waves, for example in the form of RFID elements, optical elements, such as for example reflectors or other passive elements, such as for example objects, dots, strips, images etc. Traffic guiding elements, in particular traffic cones, which are provided with reflectors are provided.

The advantage of such a method is that there is no need for any additional control units or a costly programming for the definition of an action area or of actions of the device. The action area can be defined simply by positioning the references.

The object is also achieved by a system which comprises a device for the automatic cleaning of dirty surfaces and one or more references.

Such a system is particularly advantageous since it is easy to use. Furthermore, in its application it provides a high degree of flexibility for the selection of the action area.

The invention will be explained in more detail below with reference to exemplary embodiments in figures. In the drawings:

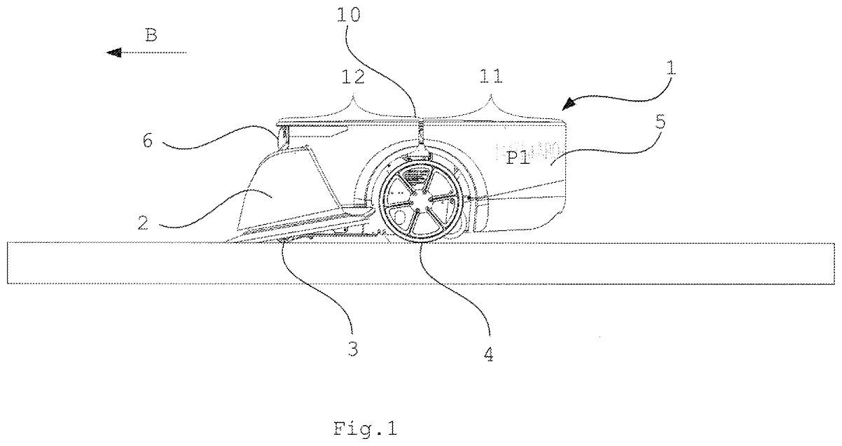

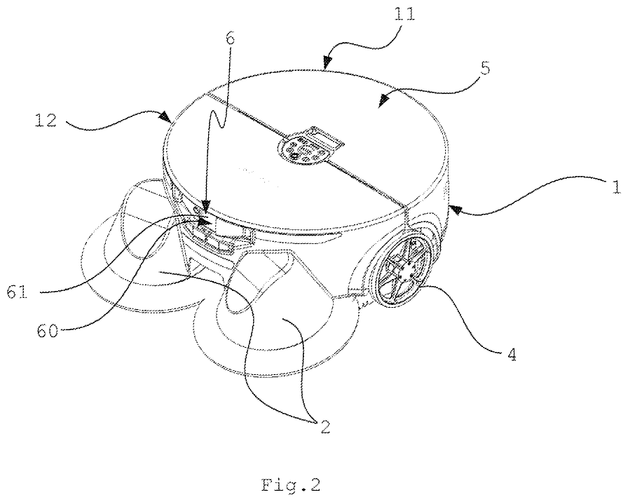

FIG. 1 shows a side view of a device in a first embodiment,

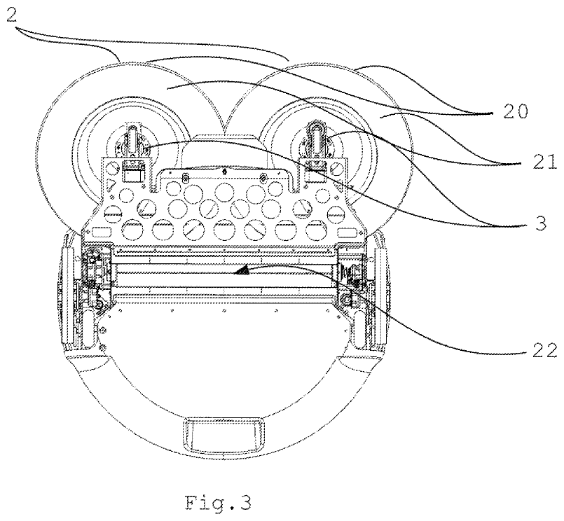

FIG. 2 shows a perspective illustration of the embodiment of the device shown in FIG. 1,

FIG. 3 shows a view from below of the embodiment of the device shown in FIG. 1,

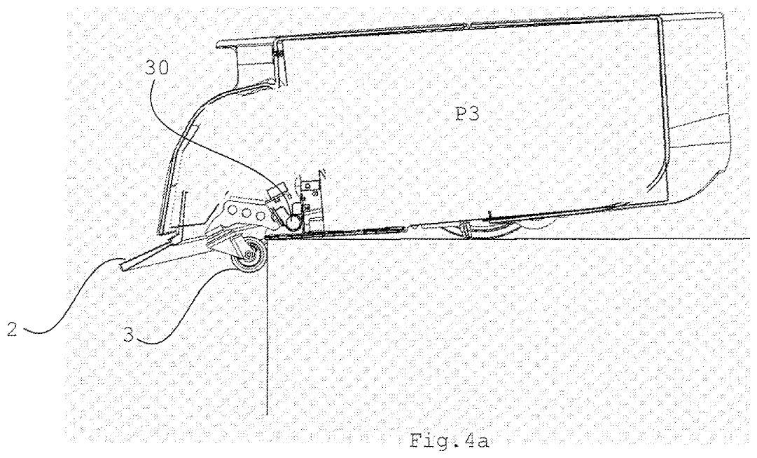

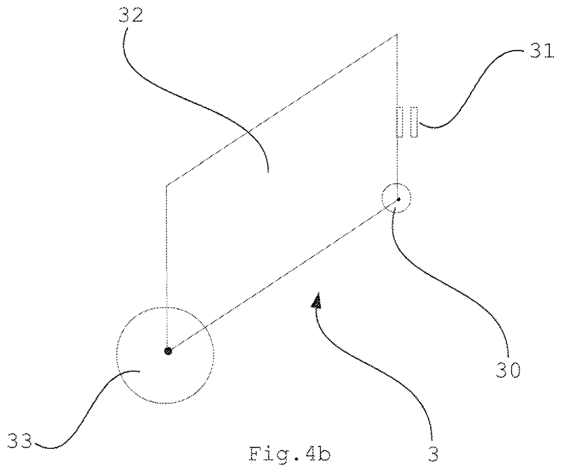

FIG. 4a shows a side view of the embodiment of the device shown in FIG. 1, in an operating position when the level of the floor changes,

FIG. 4b shows a diagram of a folding apparatus of the device when the level of the floor changes,

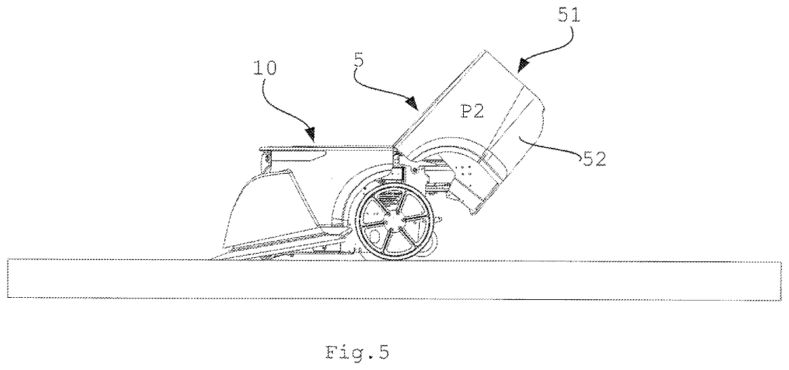

FIG. 5 shows a side view of the embodiment of the device shown in FIG. 1, in an emptying position,

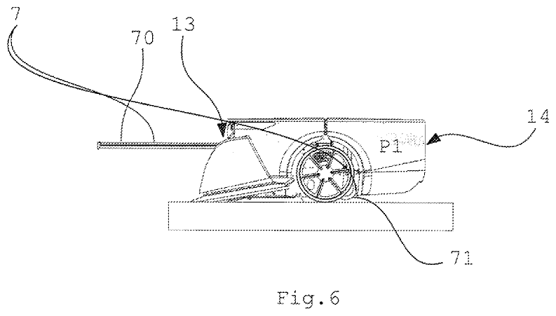

FIG. 6 shows a side view of the embodiment of the device shown in FIG. 1, in an operating position with a pulled-out handle,

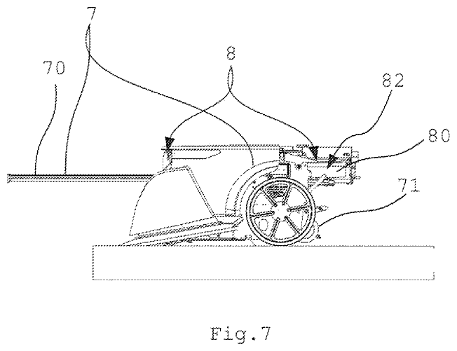

FIG. 7 shows a side view of the embodiment of the device shown in FIG. 1, in the operating position with a pulled-out handle and without a dirt receptacle space,

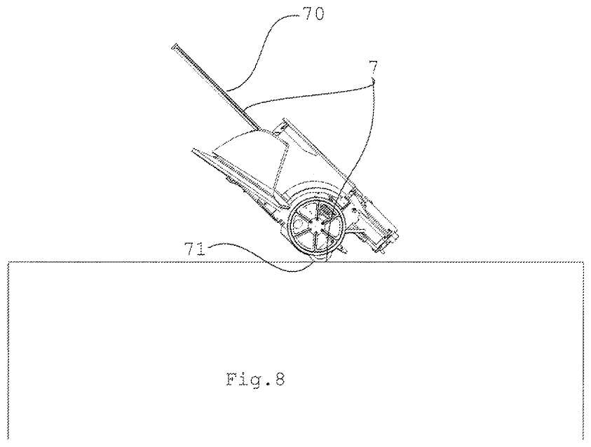

FIG. 8 shows a side view of the embodiment of the device shown in FIG. 1, in a transportation position with a pulled-out handle,

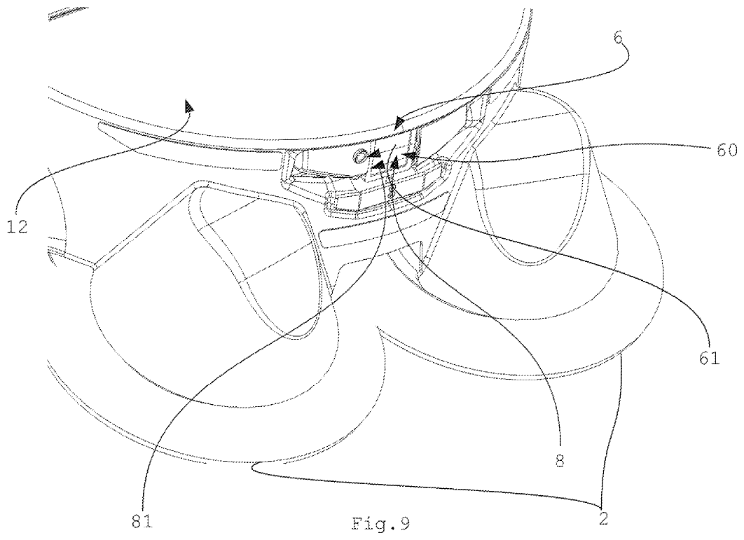

FIG. 9 shows an illustration of an exhaust air guide arranged on an optical detection system,

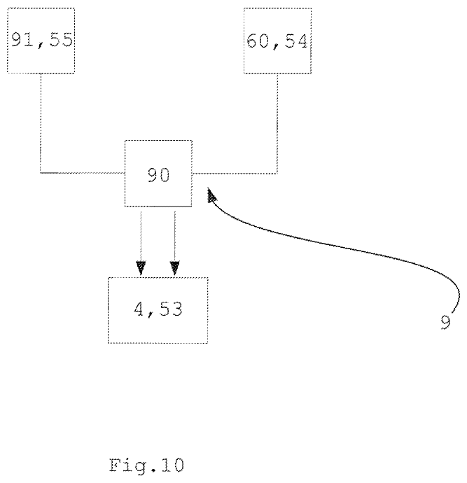

FIG. 10 shows a schematic illustration of the control of the device,

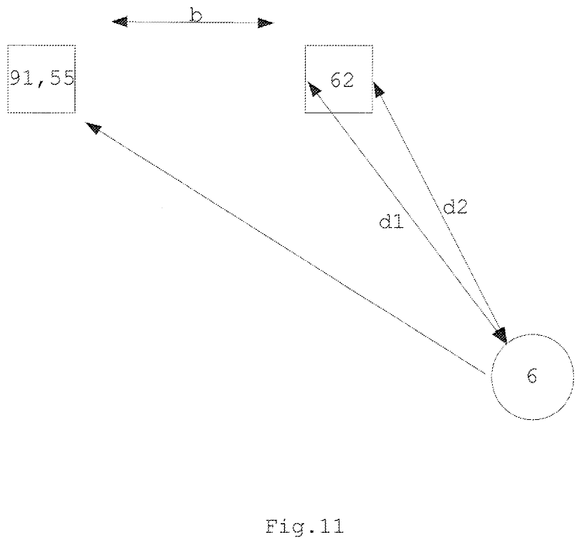

FIG. 11 shows a schematic illustration of the location determining system of the device, and

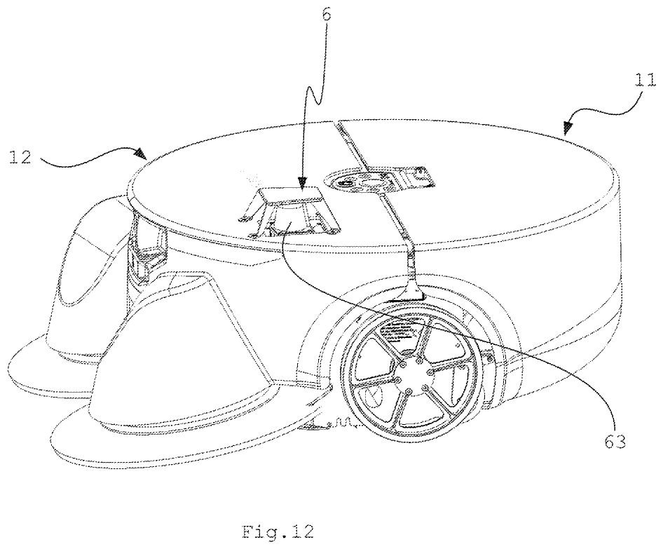

FIG. 12 shows a perspective illustration of a further embodiment of the device.

A device 1 which is illustrated in FIG. 1 serves for automatically carrying out cleaning in an industrial environment with dirt emissions. The device 1 contains a housing 10 which, when viewed in the direction of movement B, is divided into a front area 12 and a rear area 11 by two drive wheels 4. In the front area 12 there is a cleaning apparatus 2, partially concealed by the housing 10. The cleaning apparatus 2 contains two rotating brushes 20 lying one next to the other (see FIG. 3). Arranged behind a front edge of the rotating brushes 20 there is in each case a sensor 3 in the form of a folding device in the front region 12 in the direction of movement B (see FIGS. 3/4). In addition, in the front area 12 there is an optical detection system 6. The rear area 11 comprises an emptying apparatus 5 and a dirt receptacle space 51 (see FIG. 5). In FIG. 1, the emptying apparatus 5 is shown in an operating position P1.

FIG. 2 shows, in the front area 12 above the cleaning apparatus 2, a camera 60 of the optical detection system 6 which serves to determine the position of the device 1 and/or to detect obstacles. The camera 60 has a lens 61. The optical detection system 6 determines the location of e.g. an image which is located in space (see also FIG. 11). When the image is detected, a relative position of the device 1 can be determined by means of a measurement of two distances d1, d2 with respect to the image, on in each case one edge of the image (see FIG. 11). In addition, the image is assigned a code which, when detected by the optical detection system 6, brings about the execution of an action, determined by the code, of the device 1. Instead of the image it is possible to arrange markings, e.g. two signal strips or two signal dots, in the space. After the determination of the relative position, the device 1 moves automatically to a position which is determined relative to the location of the code. Alternatively or additionally, an action is performed on the basis of the determined data.

Examples of the position of an image or of the markings can be a charging station 91 or a dirt receptacle station 55 for emptying the dirt receptacle space 51 (see FIG. 10).

A computer unit 90 of the device can comprise one or more setpoint criteria (see FIG. 10). As long as a setpoint value does not correspond to the setpoint criterion, the cleaning process of the device 1 is continued. On the other hand, if the setpoint value corresponds to the setpoint criterion, the device 1 performs the action which is provided for it. This may be, for example, starting up of the charging station 91 in order to charge the battery, or starting up of the dirt receptacle station 55 in order to empty the dirt receptacle space 51.

FIGS. 3, 4a and 4b show the cleaning apparatus 2 and the two folding devices 3 in the lower view and side view of the device 1. The cleaning apparatus 2 comprises two rotating circular brushes 20, each with a brush disk 21. One or more further brushes, e.g. for picking up fine dust, typically a brushes rotating about a horizontal axis (see horizontal brush 22 in FIG. 3), are also conceivable. Both circular brushes 20 are arranged one next to the other, in the front area 12 of the device 1. The two folding devices 3 are arranged within the periphery of the brushes 20, preferably eccentrically with respect to the brush disks 21, and can each pivot about an axis (see FIG. 4b). The folding device 3 which is illustrated schematically in FIG. 4b comprises in each case an axis 30, a contact point 31 and a caster with a carrier 32 and a wheel 33. The carrier 32 with the wheel 33 is pivotably arranged on the axis 30. As long as the carrier 32 is located in a normal position, the contact point 31 with a contact which is arranged on the carrier 32 is closed. If there is no change in the level of the floor, the cleaning process is continued by the device 1. When the level of the floor changes, the carrier 32 pivots downward, and the electrical contact point 31 is opened. The device 1 stops and preferably transmits a signal and/or changes its direction of movement, in order to avoid the change in the level of the floor. FIG. 4a shows the device 1 in a stop position P3 at which there is a change in the level of the floor and the folding device 3 is folded downward.

The two folding devices 3 can be triggered independently of one another. Depending on the angle at which the device 1 is at with respect to the change in the level of the floor, one or both folding devices 3 can be folded downward.

FIG. 5 shows the emptying apparatus 5 of the device 1. The emptying apparatus 5 comprises the dirt receptacle space 51, a closure element 52, a filling level sensor 54 (see FIG. 10) and an internal drive 53 (see FIG. 10). The closure element 52 can be moved automatically by means of the drive 53, for example by pivoting. The closure element 52 can assume two positions, either an opened position or a closed position.

FIG. 5 shows the device 1 in an emptying position P2, when the closure element 52 is in the opened position. Emptying is carried out using a controller 9 (see FIG. 10). The controller 9 comprises the computer unit 9 and the filling level sensor 54. The filling level sensor 54 determines the residual volume of the dirt receptacle space 51. The computer unit 90 compares the residual volume determined by the filling level sensor 54 with a specified setpoint value. The filling level sensor 54 is, for example, an ultrasonic sensor which is contactless and insensitive to dirt. However, a tactile sensor is alternatively conceivable. It is also conceivable to determine the filling level via the weight or on the basis of the driving behavior of the device 1 by measuring the acceleration. If the residual volume corresponds to the specified setpoint value, the computer unit 90 activates the drive element 4 of the device 1. The device 1 then moves into an adjacent position to a dirt collection area of the dirt receptacle station 55. The reaching of the adjacent position by the dirt collection area is detected by the optical detection system 6 (see FIG. 2) using the camera 60. This in turn activates, via the computer unit 90, the drive 53, which automatically opens the closure element 52. The dirt receptacle space 51 which is filled with dirt is emptied into the dirt collection area of the dirt receptacle station 55. The dirt collection area can be a dedicated container or else simply be a hole in the floor.

FIGS. 6-8 show how manual transport of the device 1 is carried out.

FIG. 6 shows a transportation device 7 of the device 1. The device 1 is illustrated in an operating position P1 with a pulled-out handle 70. The handle 70 is arranged at one end 13 of the device 1. At an opposite end 14, at least one wheel 71 is arranged, which wheel 71 is not in contact with the floor in the operating position P1. In order to transport the device, it is moved into a transportation position (see FIG. 8).

In FIG. 7, the device 1 is illustrated in the operating position P1 with the pulled-out handle 70 without the dirt receptacle space 51 (see FIG. 5). The dirt receptacle space 51 or parts thereof are removed so that the device can be moved into the transportation position (see FIG. 8).

A cover of the dirt receptacle space or the entire dirt receptacle space 51 can be attached (not shown) to the handle 70 or to the housing 10 (see FIG. 1) using a securing device (e.g. by means of a latching mechanism or by means of a magnet).

FIG. 8 shows how the wheel 71 is moved into contact with the floor in the absence of the dirt receptacle space 51 and by lifting up the handle 7. Manual transportation of the device 1 is possible.

FIG. 9 shows an exhaust air guide 8 for removing dirt from the area adjacent to the lens 61 of the detection unit 60. This is typically a camera of the optical detection system 6.

Air which is guided through the exhaust air guide 8 is generated by a suction apparatus 82 (see FIG. 7). The latter is provided with a filter arrangement 80. The suction apparatus 82 and the filter arrangement 80 are arranged in the rear area 11 of the device 1. The optical detection system 7 is arranged in the front region of the device 1.

The exhaust air guide 8 is arranged in such a way that exhaust air 81 which is generated by the suction apparatus 82 is directed to the optical detection system 6 into the front area 12 of the device 1 and flows over the surface of the lens 61 of the camera 60 (see arrows in FIG. 9).

FIG. 10 shows a diagram of the essential components of the controller 9 of the device 1. The controller 9 comprises the computer unit 90, the filling level sensor 54 or the camera 60, the drive element 4 or the internal or external drive 53. The controller serves to start up the dirt receptacle station 55 or the charging station 91 and to perform actions when these stations are reached. The filling level sensor 54 or the camera 60 detect a setpoint criterion. The latter is compared with a specified setpoint value using the computer unit 90. If the setpoint criterion and the setpoint value correspond, the drive element 4 or the internal or external drive 53 is activated, and the device 1 moves to the dirt receptacle station 55 or the charging station 91. If the device 1 reaches the dirt receptacle station 55 or the charging station 91, the respective action, e.g. charging, emptying, is carried out.

FIG. 11 shows a system for determining the location of the device 1. The location determining system comprises a signal board 62, the optical detection system 6 and the computer unit 90 (see FIG. 10). The system serves in particular to determine the location of the device with respect to the dirt receptacle station 55 or the charging station 91. The optical detection system 6 detects the signal board 62 which can contain, for example, an image and/or a code. The computer unit 90 determines on the basis of the distances d1, d2 from the signal board edges 62 in order to determine the relative position with respect to the signal board 62. The device 1 actuates the dirt receptacle station 55 or the charging station 91 on the basis of the relative position and performs an action which is defined by the image or the code. Instead of an image it is also possible to provide individual markings.

FIG. 12 shows, in the front area 12 above the cleaning apparatus 2, a LIDAR sensor 63 of the optical detection system 6 which serves to determine the position of the device 1 and/or to detect obstacles. Furthermore, the embodiment in FIG. 12 corresponds essentially to the embodiment system according to FIG. 11.

1. A device for automatically performing an activity comprising:
at least one sensor for preventing a fall and
at least one drive element,
wherein the drive element defines a rear region and a front region of the device with respect to an intended direction of movement, and
the sensor is a mechanical sensor and is designed to detect a change in the level of a floor through contact with the floor, and is arranged in the front region.

2. The device according to claim 1, wherein the sensor is designed to measure by means of pressure, extension or force.

3. The device according to claim 1, wherein the sensor is embodied integrated into a carrier of a wheel.

4. The device according to claim 1, wherein the sensor is spatially arranged in a region of brushes.

5. The device according to claim 2, wherein the sensor is embodied integrated into foldable casters.

6. A device for automatically cleaning dirty surfaces comprising at least one cleaning apparatus,
wherein the device comprises an emptying apparatus comprising a dirt receptacle space for receiving the collected dirt, the emptying apparatus can move automatically between an operating position, in which dirt can be received from the cleaning apparatus, and an emptying position, in which dirt can be emptied.

7. The device according to claim 6, wherein the dirt receptacle space has a closure element which is movable arranged on the device.

8. The device according to claim 6, wherein the emptying apparatus comprises a filling level sensor for determining a residual volume.

9. A device for automatically cleaning dirty surfaces comprising:
at least one cleaning apparatus
wherein the device comprises a blowing apparatus for generating an airstream, and a filter arrangement for filtering particles from the air,
as well as an optical detection system,
an air guide of the blower apparatus and an exhaust air guide of the filter arrangement is arranged in such a way that air can be guided past the optical detection system.

10. The device according to claim 1, wherein the cleaning apparatus comprises a sweeping apparatus.

11-18. (canceled)
